(19) United States
(12) Patent Application Publication
(10) Pub. No.: US 2025/0299037 A1
(43) Pub. Date: Sep. 25, 2025

(54) METHOD AND SYSTEM OF GENERATING A COMPILER-AWARE NEURAL NETWORK MODEL

(71) Applicant: MediaTek Singapore Pte. Ltd., Solaris (SG)

(72) Inventors: Jung Hau FOO, Solaris (SG); Hantao HUANG, Solaris (SG)

(73) Assignee: MediaTek Singapore Pte. Ltd., Solaris (SG)

(21) Appl. No.: 18/612,576

(22) Filed: Mar. 21, 2024

(51) Int. Cl. G06N 3/08; G06N 3/04

(52) U.S. Cl. CPC G06N 3/08; G06N 3/04

(57) ABSTRACT

This disclosure provides a method and a system for constructing a neural network. Processing circuitry of the system obtains compilation optimization information of a compilation of a neural network model. The compilation optimization information indicates one or more modifications to the neural network model during the compilation of the neural network model. The one or more modifications are based on hardware information of a target hardware that the neural network model is to be deployed onto. The processing circuitry modifies the neural network model based on the one or more modifications indicated by the compilation optimization information, compiles the modified neural network model into a compiled neural network model, and deploys the compiled neural network model onto the target hardware.

### TECHNICAL FIELD

The present disclosure relates to constructing a neural network, and more specifically, to generating a compiler-aware neural network model.

### BACKGROUND

Constructing a neural network can include training a neural network model, compiling the trained neural network model into a compiled model, and deploying the compiled model onto a target hardware. The compilation of the trained neural network model may optimize the trained neural network model based on hardware information of the target hardware, leading to a performance difference of the trained neural network model before and after the optimization.

### SUMMARY

Aspects of the disclosure provide a method for constructing a neural network. The method includes obtaining compilation optimization information of a compilation of a neural network model. The compilation optimization information indicates one or more modifications to the neural network model during the compilation of the neural network model. The one or more modifications are based on hardware information of a target hardware that the neural network model is to be deployed onto. The method further includes modifying the neural network model based on the one or more modifications indicated by the compilation optimization information, compiling the modified neural network model into a compiled neural network model, and deploying the compiled neural network model onto the target hardware.

In an embodiment, the method includes modifying at least one of a topology, a computation order, a quantization parameter, or an operation parameter of an operation layer of the neural network model.

In an embodiment, the neural network model is an untrained model before the compilation optimization information is obtained, and the method includes training the neural network model based on the one or more modifications indicated by the compilation optimization information.

In an embodiment, the neural network model is a trained model before the compilation optimization information is obtained, and the method includes retraining or tuning (e.g., fine-tuning) the neural network model based on the one or more modifications indicated by the compilation optimization information.

In an embodiment, the neural network model is a trained model before the compilation optimization information is obtained, the method includes calibrating the neural network model based on the one or more modifications indicated by the compilation optimization information. In an example, the method includes calibrating the neural network model based on the one or more modifications indicated by the compilation optimization information and calibration data. The calibration data can include a dataset that is representable to an inference data distribution. In an example, the inference data distribution can refer to a distribution that matches (as closely as possible) input data of the neural network model during an actual use after being deployed.

In an embodiment, the compilation of the neural network model includes a tiled-fused computation of the neural network model, and the compilation optimization information indicates tiling configuration information and fusion configuration information of the tiled-fused computation.

In an embodiment, the hardware information of the target hardware includes hardware type information of the target hardware.

In an embodiment, the method includes applying a model quantization to the neural network model based on the one or more modifications indicated by the compilation optimization information. In an example, the model quantization is applied during or after a training process that trains the neural network model.

Aspects of the disclosure provides a system for constructing a neural network. Processing circuitry of the system obtains compilation optimization information of a compilation of a neural network model. The compilation optimization information indicates one or more modifications to the neural network model during the compilation of the neural network model. The one or more modifications are based on hardware information of a target hardware that the neural network model is to be deployed onto. The processing circuitry modifies the neural network model based on the one or more modifications indicated by the compilation optimization information, compiles the modified neural network model into a compiled neural network model, and deploys the compiled neural network model onto the target hardware.

In an embodiment, the processing circuitry of the system modifies at least one of a topology, a computation order, a quantization parameter, or an operation parameter of an operation layer of the neural network model.

In an embodiment, the neural network model is an untrained model before the compilation optimization information is obtained, and the processing circuitry trains the neural network model based on the one or more modifications indicated by the compilation optimization information.

In an embodiment, the neural network model is a trained model before the compilation optimization information is obtained, and the processing circuitry retrains or tunes (e.g., fine-tunes) the neural network model based on the one or more modifications indicated by the compilation optimization information.

In an embodiment, the neural network model is a trained model before the compilation optimization information is obtained, the processing circuitry calibrates the neural network model based on the one or more modifications indicated by the compilation optimization information. In an example, the processing circuitry calibrates the neural network model based on the one or more modifications indicated by the compilation optimization information and calibration data. The calibration data can include a dataset that is representable to an inference data distribution. In an example, the inference data distribution can refer to a distribution that matches (as closely as possible) input data of the neural network model during an actual use after being deployed.

In an embodiment, the compilation of the neural network model includes a tiled-fused computation of the neural network model, and the compilation optimization information indicates tiling configuration information and fusion configuration information of the tiled-fused computation.

In an embodiment, the hardware information of the target hardware includes hardware type information of the target hardware.

In an embodiment, the processing circuitry applies a model quantization to the neural network model based on the one or more modifications indicated by the compilation optimization information. In an example, the model quantization is applied during or after a training process that trains the neural network model.

Aspects of the disclosure provide a non-transitory computer-readable medium storing instructions which when executed by an apparatus cause the apparatus to perform any one or a combination of the above methods.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary convolutional neural network (CNN) model according to embodiments of the disclosure;

FIG. 2 shows an exemplary tiled-fused computation of the CNN model according to embodiments of the disclosure;

FIG. 3 shows an exemplary process of obtaining a compiler-aware neural network model according to embodiments of the disclosure;

FIG. 4 shows an exemplary process of obtaining a compiler-aware neural network model using a calibration process according to embodiments of the disclosure;

FIG. 5 shows another exemplary process of obtaining a compiler-aware neural network model using a calibration process according to embodiments of the disclosure;

FIG. 6 shows three exemplary neural network computation graphs according to embodiments of the disclosure;

FIG. 7 shows an exemplary process of obtaining a compiler-aware quantization-aware trained (QATed) neural network model according to embodiments of the disclosure;

FIG. 8 shows an exemplary process of obtaining a compiler-aware post training quantization (PTQ) neural network model according to embodiments of the disclosure;

FIG. 9 shows another exemplary process of obtaining a compiler-aware PTQ neural network model according to embodiments of the disclosure;

FIGS. 10A-10C show three exemplary neural network computation graphs, respectively, according to embodiments of the disclosure;

FIG. 11 shows a flowchart outlining a process according to embodiments of the disclosure; and

FIG. 12 shows an exemplary computer system according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of deploying a neural network model will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

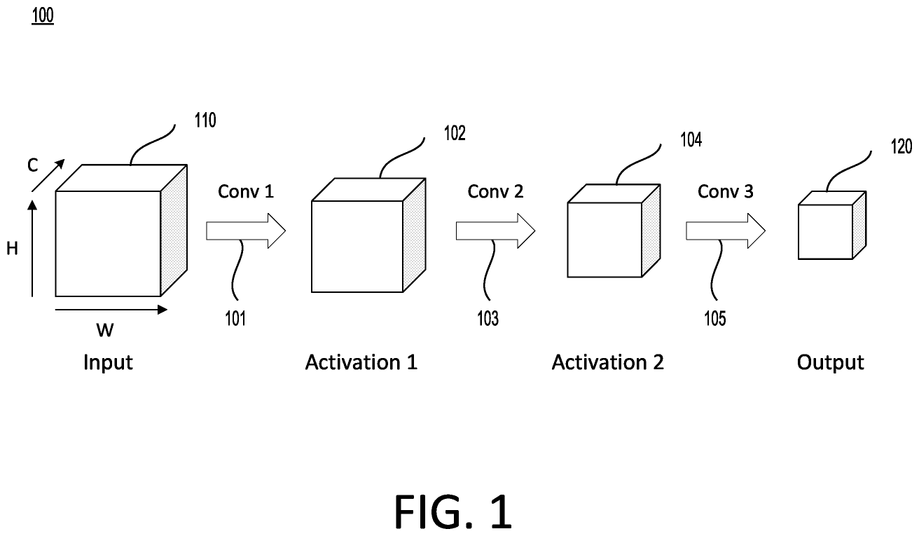

FIG. 1 shows an exemplary convolutional neural network (CNN) model 100 according to embodiments of the disclosure. The CNN model 100 can include three convolutional layers 101, 103, and 105 and two activation layers 102 and 104. In the CNN model 100, an input 110 can be processed sequentially through all the layers 101-105 to obtain an output 120. In an example, the input 110 can be a tensor and the output 120 can a scalar, a vector, a matrix, or a tensor. In addition, it is noted that a number of layers and/or a type of layers are not limited in this disclosure. In an example, the CNN model 100 can include more than three convolutional layers, more than two activation layers, and/or one or more other types of layers such as a dropout layer, a batch normalization layer, or the like.

According to aspects of the disclosure, constructing a neural network can include training a neural network model, compiling the trained neural network model into a compiled model, and deploying the compiled model onto a target hardware. The compilation of the trained neural network model can perform various optimizations on the trained neural network model based on hardware information of the target hardware. For example, the compilation of the trained neural network model can perform an optimization on the trained neural network model to allow a tiled and fused (or tiled-fused) computation of the trained neural network model on the target hardware. With the tiled-fused computation, a computation order (or sequence) of the trained neural network model can be reordered so that the target hardware can compute a tensor tile-by-tile across layers instead of an entire tensor at once, or to enable multiprocessing of the target hardware by assigning each core of the target hardware to a respective tile that is fused across layers.

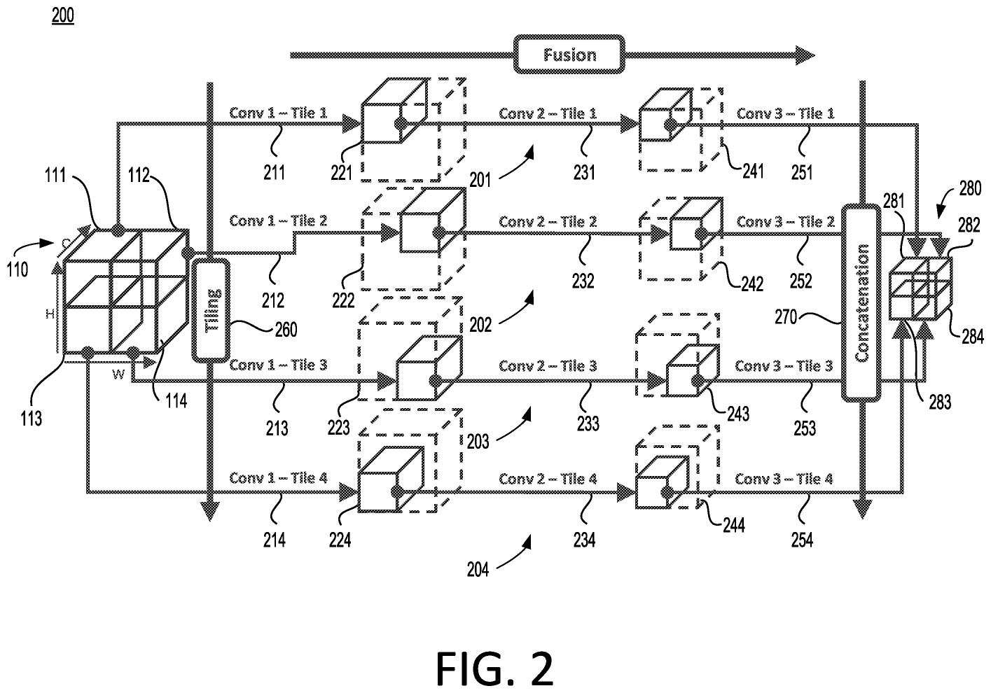

FIG. 2 shows an exemplary tiled-fused computation 200 of the CNN model 100 according to embodiments of the disclosure. In the tiled-fused computation 200, the input 110 in the CNN model 100 can be decomposed into four input slices (or tiles) 111-114 through a tiling process 260. The input slices 111-114 can be processed through processing channels (or paths) 201-204 to obtain output slices 281-284, respectively. Each input slice can be processed through a separate processing channel to obtain a respective output slice. Each processing channel can include three convolution layers and two activation layers. For example, the processing channel 201 can include three convolution layers 211, 231, and 251, and two activation layers 221 and 241. Data processing in all the processing channels can be performed in parallel. The four output slices 281-284 can be merged into an output 280 through a concatenation process 270. It is noted that a number of input slices that the input can be decomposed into, or a number of processing channels is not limited in this disclosure.

It can be seen that a topology (or architecture) and/or computation order of a neural network model can be changed after a compilation of the neural network. However, knowledge on the changes of the topology and/or computation order of the neural network model may be limited for a training process of the neural network model when the training process is performed before the compilation of the neural network model. For example, tiling and fusion configuration information of the tiled-fused computation 200 may be unavailable for the training process since the tiling and fusion configuration information is dependent on hardware information of a target hardware that the neural network model is to be deployed onto. Accordingly, without the knowledge of the compilation optimization information, it is hard to accurately predict the performance of the neural network model during the training process of the neural network model.

This disclosure provides methods for training a neural network model with knowledge of compilation optimization information of a compilation of the neural network model. In the methods, the compilation optimization information can be obtained before the neural network model is trained, so that the neural network model can be trained with the knowledge of the compilation optimization information. Alternatively, if the neural network model is already trained before the compilation optimization information is obtained, the neural network model can be retrained or tuned (e.g., fine-tuned) or calibrated after the compilation optimization information is obtained, so that the retrained or tuned or calibrated neural network model can be obtained with the knowledge of the compilation optimization information.

In this disclosure, a neural network model with knowledge of compilation optimization information can be referred to as a compiler-aware neural network model.

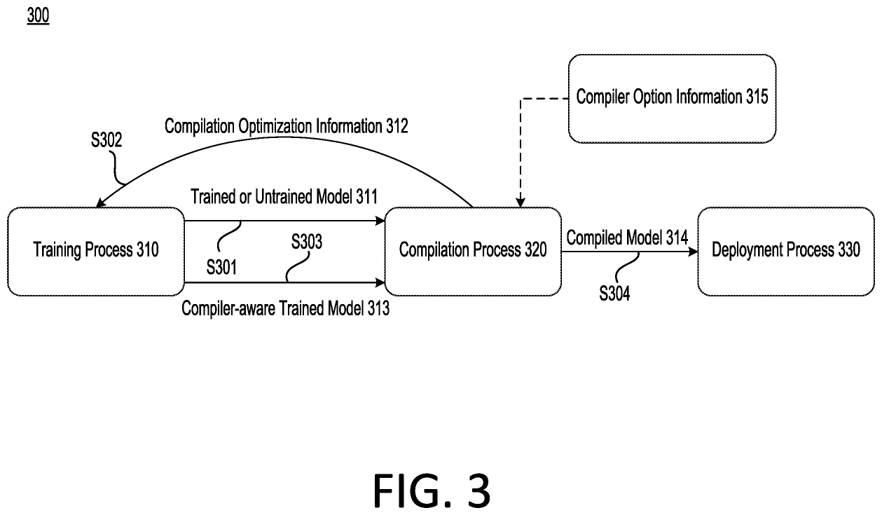

FIG. 3 shows an exemplary process 300 of obtaining a compiler-aware neural network model according to embodiments of the disclosure. In the process 300, a neural network model 311, which can be an untrained model or a trained model that is trained through a neural network training process 310, can go through a compilation process 320 to obtain compilation optimization information 312 of the compilation process 320. The compilation optimization information 312 can indicate (or include) one or more changes (or modifications) of the neural network model 311 during the compilation process 320. The one or more changes are based on hardware information of a target hardware that the neural network model 311 (or a compiled version of the neural network model 311) is to be deployed onto.

The compilation optimization information 312 can be feedback to the neural network training process 310. Based on the compilation optimization information 312 indicating (or including) the one or more changes of the neural network model 311, the neural network training process 310 can train the neural network model 311 (or retain or tune the neural network model 311 if the neural network model 311 is already trained before being input into the compilation process 320) to obtain a compiler-aware neural network model (or compiler-aware trained model) 313. Then, the compiler-aware neural network model 313 can go through the compilation process 320 to generate a compiled model 314, which can be considered as the compiled version of the neural network model 311. The compiled model 314 can be deployed onto the target hardware through a deployment process 330. The process 300 can be described in details as follows. The process 300 may start at step S301.

At step S301, the neural network model 311 can be input into the compilation process 320. Through the compilation process 320, the compilation optimization information 312 of the compilation process 320 can be obtained. In an example, compiler option information 315 can be used in the compilation process 320, and the compilation optimization information 312 can be generated based on the compiler option information 315. The compiler option information 315 can include, for example, hardware type information of the target hardware that the complied neural network model 314 is to be deployed onto. The hardware type information can indicate that the target hardware is a central processing unit (CPU), a graphical processing unit (GPU), an accelerated processing unit (APU), a tensor processing unit (TPU), or the like. Then, the process 300 can proceed to step S302.

At step S302, the obtained compilation optimization information 312 can be feedback to the neural network training process 310. The training process 310 can train the neural network model 311 based on the compilation optimization information 312 in order to generate the compiler-aware neural network model 313. Then, the process 300 can proceed to step S303.

At step S303, the compiler-aware neural network model 313 can be input into the compilation process 320. Through the compilation process 320, the compiler-aware neural network model 313 can be compiled into the compiled model 314. In an example, the compiler option information 315 can be used in the compilation process 320, and the compiled model 314 can be generated based on the compiler option information 315. The compiler option information 315 can include, for example, the hardware type information of the target hardware that the complied neural network model 314 is to be deployed onto. Then, the process 300 can proceed to step S304.

At step S304, the compiled neural network model 314 can be deployed onto the target hardware through the deployment process 330.

It is noted that in the process 300 the neural network model 311 can be an untrained model or a trained model before the step S301. When the neural network model 311 is an untrained model, the training process 310 is not performed on the neural network model 311, although the neural network model 311 can still be output from the training process 310 at step S301.

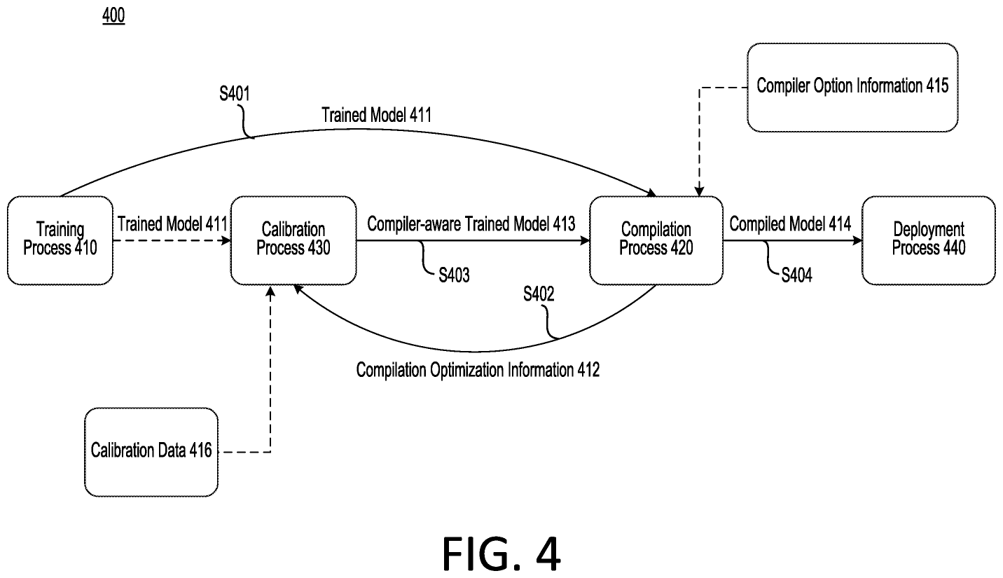

According to aspects of the disclosure, a calibration process (e.g., calibration process 430 in FIG. 4) can be used to generate the compiler-aware neural network model 313 by tuning the neural network model 311 based on the compilation optimization information 312.

In an embodiment, due to security or privacy considerations, the training process 310 may not be viable after the compilation optimization information 312 becomes accessible or is obtained, the obtained compilation optimization information 312 can be input into the calibration process to generate the compiler-aware neural network model 313. The calibration process is separated from the training process 310. In an example, when an improvement provided by the calibration process to the neural network model 311 is greater than a threshold based on one or more criteria or metrics, such as accuracy or performance of the neural network model 311, the neural network model 311 may not need to go through the training process 310 for retraining or tuning after the compilation optimization information 312 is obtained.

In an embodiment, the compiler-aware trained model 313 can include metadata that was not in the neural network model 311. The metadata can be created from the compiler-aware training process 310 at step S302 (or the calibration process 430 for example). The metadata can include information or data that the compilation process 320 at step S303 (or the calibration process 430 for example) can utilize and apply to the compiler-aware model 313. For example, the information or data can include additional quantization parameters in a tile dimension for a tiled-fused computation.

In an embodiment, the metadata can be applied when the changes from the neural network model 311 to the compiler-aware trained model 313 becomes meaningful during the compilation process 320. For example, the additional quantization parameters in the tile dimension of the tiled-fused computation are not applied until after a tiling optimization of the tiled-fused computation has been applied during the compilation process 320. After the tiling optimization has been applied, the additional quantization parameters that are trained/computed during the training process 310 and included in the metadata can be applied by the compiler to the compiler-aware trained model 313.

In an embodiment, when a compiler optimization is directly applied to the neural network model 311 to obtain the compiler-aware trained model 313 during the compiler-aware training process 310, the metadata may not be applied. In such an embodiment, the same optimization in the compilation process 320 can be avoided. For example, based on the compilation optimization information 312, the training process 310 can tile the neural network model 311 using the tiling configuration used in the compilation process 320. By this way, the compiler-aware trained model 313 has already been tiled before being input into the compilation process 320, which frees the compiler from doing the same tiling process again. Accordingly, in such an embodiment, there is no need for the metadata.

It is noted that when the compilation optimization information 312 includes information of multiple compiler optimization steps, the metadata may be applied if at least one of the multiple compiler optimization steps has to be performed during the compilation process 320.

The use of the metadata can also be applied to a calibration process such as calibration process 430/522, a quantization-aware training process 710/910, a post training quantization process 830/930, and the like.

FIG. 4 shows an exemplary process 400 of obtaining a compiler-aware neural network model using a calibration process according to embodiments of the disclosure. In the process 400, a neural network model 411, which is trained through a neural network training process 410, can go through a compilation process 420 to obtain compilation optimization information 412 of the compilation process 420. The compilation optimization information 412 can indicate (or include) one or more changes of the neural network model 411 during the compilation process 420. The one or more changes are based on hardware information of a target hardware that the neural network model 411 (or a compiled version of the neural network model 411) is to be deployed onto.

The obtained compilation optimization information 412 can be feedback to a calibration process 430 that is separated from the training process 410. Based on the compilation optimization information 412, the calibration process 430 can modify (and/or tune) the neural network model 411 to generate a compiler-aware neural network model 413. Then, the compiler-aware neural network model 413 can go through the compilation process 420 to generate a compiled model 414. The compiled model 414 can be deployed onto the target hardware through a deployment process 440. The process 400 can be described in details as follows. The process 400 may start at step S401.

At step S401, the neural network model 411 can be input into the compilation process 420. Through the compilation process 420, the compilation optimization information 412 of the compilation process 420 can be obtained. In an example, compiler option information 415 can be used in the compilation process 420, and the compilation optimization information 412 can be generated based on the compiler option information 415. The compiler option information 415 can include, for example, hardware type information of the target hardware that the complied neural network model 414 is to be deployed onto. The hardware type information can indicate that the target hardware is a CPU, a GPU, an APU, a TPU, or the like. Then, the process 400 can proceed to step S402.

At step S402, the obtained compilation optimization information 412 can be feedback to the calibration process 430. The calibration process 430 can calibrate one or more parameters of the neural network model 411 based on the compilation optimization information 412 in order to generate the compiler-aware neural network model 413. In an example, the calibration process 430 can calibrate one or more quantization parameters that are newly generated with the knowledge of the compilation optimization information 412. The one or more newly generated (and subsequently trained/calibrated) quantization parameters can be stored in the metadata to be passed to the compilation process 420. In an example, calibration data 416 can be used in the calibration process 430, and the compiler-aware neural network model 413 can be generated based on the compilation optimization information 412 and the calibration data 416. The calibration data can include, for example, a small dataset that is representable to an inference data distribution. In an example, the inference data distribution can refer to a distribution that matches (as closely as possible) input data of the neural network model during an actual use after being deployed. Then, the process 400 can proceed to step S403.

At step S403, the compiler-aware neural network model 413 can be input into the compilation process 420. Through the compilation process 420, the compiler-aware neural network model 413 can be compiled into the compiled model 414. In an example, the compiler option information 415 can be used in the compilation process 420, and the compiled model 414 can be generated based on the compiler option information 415. The compiler option information 415 can include, for example, the hardware type information of the target hardware that the complied neural network model 414 is to be deployed onto. Then, the process 400 can proceed to step S403.

At step S404, the compiled neural network model 414 can be deployed onto the target hardware through the deployment process 440.

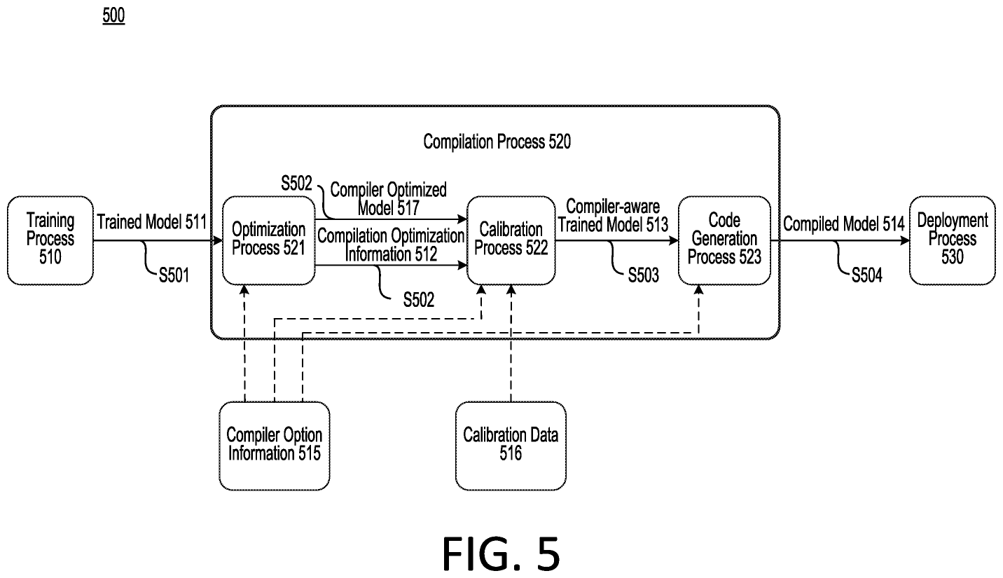

FIG. 5 shows another exemplary process 500 of obtaining a compiler-aware neural network model using a calibration process according to embodiments of the disclosure. In the process 500, a neural network model 511, which is trained through a neural network training process 510, can go through a compilation process 520. The compilation process 520 includes an optimization process 521, a calibration process 522, and a code generation process 523. The optimization process 521 can generate compilation optimization information 512 of the compilation process 520 for the neural network model 511 and a compiler optimized neural network model 517. The compilation optimization information 512 can indicate (or include) one or more changes of the neural network model 511 during the compilation process 520. The one or more changes are based on hardware information of a target hardware that the neural network model 511 (or a compiled version of the neural network model 511) is to be deployed onto.

The obtained compilation optimization information 512 and the compiler optimized neural network model 517 can be feedback to the calibration process 522. Based on the compilation optimization information 512, the calibration process 522 can modify the compiler optimized neural network model 517 to generate a compiler-aware neural network model 513. Then, the compiler-aware neural network model 513 can go through the code generation process 523 to generate a compiled model 514. The compiled model 514 can be deployed onto the target hardware through a deployment process 530. The process 500 can be described in detail as follows. The process 500 may start at step S501.

At step S501, the neural network model 511 can be input into the compilation process 520. Through the optimization process 521 of the compilation process 520, the compilation optimization information 512 of the compiler optimization process 521 and the compiler optimized neural network model 517 can be obtained. In an example, compiler option information 515 can be used in the optimization process 521, and the compilation optimization information 512 and/or the compiler optimized neural network model 517 can be generated based on the compiler option information 515. The compiler option information 515 can include, for example, hardware type information of the target hardware that the complied neural network model 514 is to be deployed onto. The hardware type information can indicate that the target hardware is a CPU, a GPU, an APU, a TPU, or the like. The process 500 can proceed to step S502.

At step S502, the obtained compilation optimization information 512 and the compiler optimized neural network model 517 can be feedback to the calibration process 522 of the compilation process 520. The calibration process 522 can calibrate (or tune) one or more parameters of the compiler optimized neural network model 517 based on the compilation optimization information 512 in order to generate the compiler-aware neural network model 513. In an example, calibration data 516 can be used in the calibration process 530, and the compiler-aware neural network model 513 can be generated based on the compilation optimization information 512 and the calibration data 516. The calibration data can include, for example, a small dataset that is representable to an inference data distribution. In an example, the inference data distribution can refer to a distribution that matches (as closely as possible) input data of the neural network model during an actual use after being deployed. The process 500 can proceed to step S503.

At step S503, the compiler-aware neural network model 513 can be input into the code generation process 523 of the compilation process 520. Through the code generation process 523, the compiler-aware neural network model 513 can be compiled into the compiled model 514. The process 500 can proceed to step S504.

At step S504, the compiled neural network model 514 can be deployed onto the target hardware through the deployment process 530.

It is noted that the calibration process 522 is not necessarily to run after the optimization process 521 and can be at anywhere in the compilation process 520, for example, can be within the optimization process 521.

It is noted that the compiler option information 515 can be used at anywhere in the compilation process 520. For example, the code generation process 523 can generate a correct output compiled format based on the hardware information obtained from the compiler option information 515.

In FIG. 4, the calibration process 430 is outside the compilation process 420, and can be referred to a pre-compilation calibration process, which can be visible to a user. In FIG. 5, the calibration process 522 is inside in the compilation process 520, and can be referred to as an in-compilation calibration process, which can be invisible to a user, especially when calibration data is not needed.

It can be seen that compilation optimization information of a compilation process can be obtained from a compiler that performs the compilation process (e.g., the compilation process 520). The compilation optimization information can also be obtained from an optimization process (e.g., the optimization process 521) of the compilation process. Accordingly, a tool that includes the optimization process can be used for obtaining the compilation optimization information. The tool can be separated from the compiler. A size of the source code of the tool can be minimized by only including the optimization process.

In an embodiment, partial or approximate compilation optimization information can be used to generate a compiler-aware neural network model, for example, when any of the following cases occurs. In case A, an exact change to a neural network model by an optimization is unavailable (e.g., when using a separate tool instead of a compiler). In case B, the optimization is unable (or is proven ineffective) to be utilized for training or calibrating the neural network model. In case C, the change to the neural network model by the optimization has no one-to-one mapping to a training framework used for training the neural network model, such as a hardware specific operation.

According to aspects of the disclosure, a model quantization can be applied on a neural network model. In the model quantization, a low precision in numerical representation can be used for static weights and/or computation of the neural network model. Through the model quantization, a small model size with a fast inference speed and a high power efficiency can be obtained for the neural network model. However, the low precision can cause a degradation of a model accuracy of the neural network model. To reduce an overall quantization error and help alleviate a model accuracy drop, a quantization grain can be increased in the model quantization. In an example, a typical hardware can only support up to per-channel quantization, and any finer quantization may require a hardware redesign.

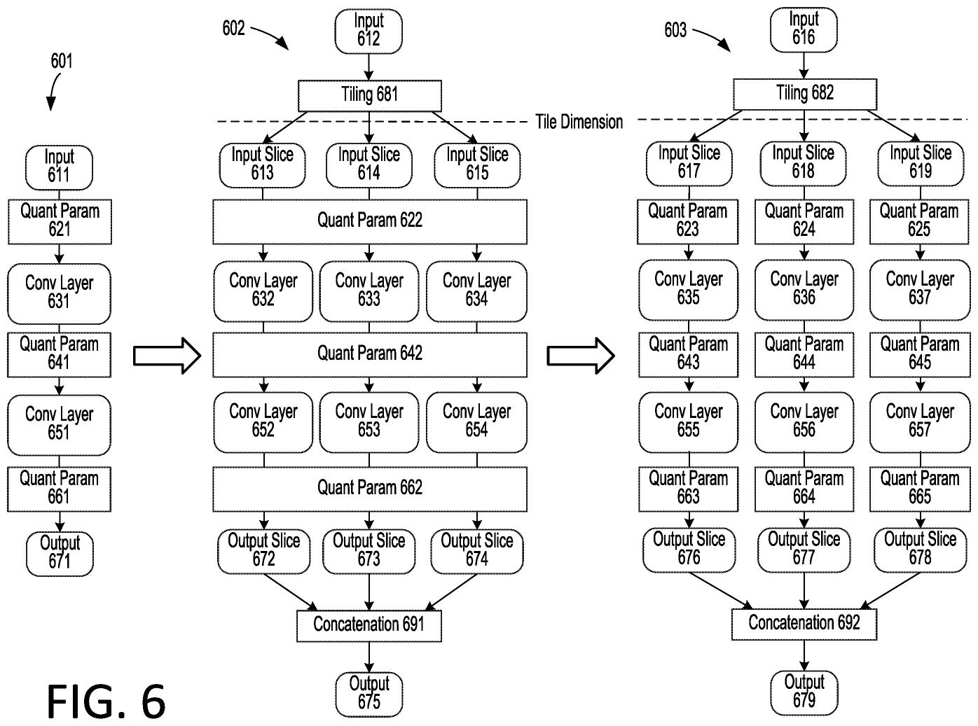

FIG. 6 shows three exemplary neural network computation graphs 601-603 according to embodiments of the disclosure. In the neural network computation graph 601, an input 611 can be quantized using a first quantization parameter 621 as a first quantized result. The first quantized result can go through a first operation layer such as a first convolution layer 631. An output from the first convolution layer 631 can be quantized using a second quantization parameter 641 as a second quantized result. The second quantized result can go through a second operation layer such as a second convolution layer 651. An output from the second convolution layer 651 can be quantized using a third quantization parameter 661 as an output 671.

The neural network computation graph 602 utilizes a tiled-fused computation. Specifically, an input 612 can be tiled into multiple input slices (or tiles) 613-615 through a tiling process 681. Each of the input slices 613-615 can be quantized using a first quantization parameter 622 as a respective first quantized result. The first quantized results can go through first operation layers such as first convolution layers 632-634, respectively. Each output from the first convolution layers 632-634 can be quantized using a second quantization parameter 642 as a respective second quantized result. The second quantized results can go through second operation layers such as second convolution layers 652-654, respectively. Each output from the second convolution layer 652-654 can be quantized using a third quantization parameter 662 as a corresponding output slice. The output slices 672-674 can be merged into an output 675 through a concatenation process 691.

It is note that compared to the neural network computation graph 601, the tiling process 681 in the neural network training process 602 can result in more processing channels and thus extra quantized results such as extra tensors. However, the extra quantized results are obtained using a same quantization parameter duplicated in a tile dimension. For example, a first same quantization parameter 622 is duplicated to quantize all input slices 613-615, a second same quantization parameter 642 is duplicated to quantize all outputs from the first convolution layers 632-634, and a third same quantization parameter 662 is duplicated to quantize all outputs from the second convolution layers 652-654. Accordingly, it can be seen that there are more quantized results (or tensors) than the number of unique quantization parameters in the neural network computation graph 602.

In order to achieve a finer grain quantization, the neural network computation graph 603 utilizes a tile-based quantization in which different quantization parameters can be used for different processing channels in a tile dimension. In the neural network training process 603, an input 616 can be tiled into multiple input slices 617-619 through a tiling process 682. The input slices 617-619 can be quantized using first quantization parameters 623-625 as first quantized results, respectively. The first quantized results can go through first operation layers such as first convolution layers 635-637, respectively. Outputs from the first convolution layers 635-637 can be quantized using second quantization parameters 643-645 as second quantized results, respectively. The second quantized results can go through second operation layers such as second convolution layers 655-657. Outputs from the second convolution layers 655-657 can be quantized using third quantization parameters 663-665 as output slices 676-678, respectively. Finally, the output slices 676-678 are merged into an output 679 through a concatenation process 692.

In the neural network computation graph 603, the quantization parameters can be different from each other or at least one quantization parameter can be different from others in a tile dimension. For example, the first quantization parameters 623-625 can be different from each other, or at least one of the first quantization parameters 623-625 can be different from others of the first quantization parameters 623-625.

It is noted that a number of and/or a type of the operation layers is not limited in this disclosure. In FIG. 6, any process can have one or more operation layers or can have another type of operation layer such as a dropout layer, a batch normalization layer, or the like. Further, a number of the quantization parameters is not limited in this disclosure. For example, a first quantization parameter 621 can be a set of first quantization parameters used to quantize the input slice 611. In addition, one or more of the input (or input slices) and/or outputs from the operation layers may not need to be quantized. For example, if the input 611 does not need to be quantized, the first quantization parameter 621 may not be used or needed.

According to aspects of the disclosure, a model quantization of a neural network model can be performed during a training process that trains the neural network model. When the model quantization is performed during the training process, quantization parameters of the model quantization can be trained together with the training of model parameters of the neural network model, and the training process can be referred to as a quantization-aware training (QAT) process.

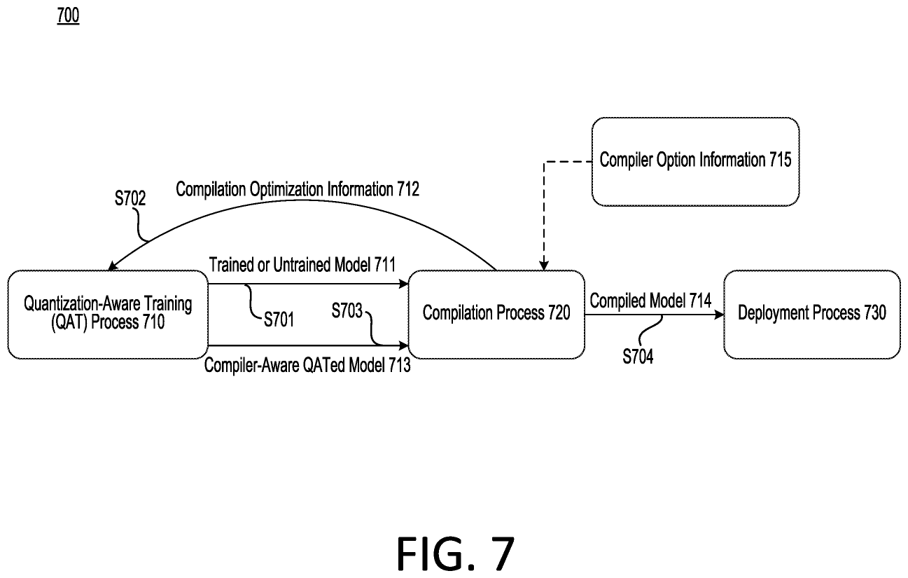

FIG. 7 shows an exemplary process 700 of obtaining a compiler-aware quantization-aware trained (QATed) neural network model according to embodiments of the disclosure. The process 700 can include a QAT process 710 which can perform a model quantization for a neural network model while training the neural network model. The QAT process 710 can train (or compute) quantization parameters used in the model quantization along with the training of model parameters of the neural network model. The process 700 can further include a compilation process 720, of which compilation optimization information 712 can be obtained by inputting a neural network model 711. The compilation optimization information 712 can include tiling and fusion configuration information of a tiled-fused computation to enhance the model quantization in the QAT process 710. For example, different quantization parameters can be used in a tile dimension to achieve a finer grain quantization, similar to the neural network training process 603. The compilation optimization information 712 can indicate (or include) one or more changes of the neural network model 711 during the compilation process 720. The one or more changes are based on hardware information of a target hardware that the neural network model 711 (or a compiled version of the neural network model 711) is to be deployed onto.

The obtained compilation optimization information 712 can be feedback to the QAT process 710. Based on the compilation optimization information 712, the QAT process 710 can train the neural network model 711 (or retain or fine-tune the neural network model 711 if the neural network model 711 is already trained before being input into the compilation process 720) to obtain a compiler-aware QATed neural network model 713. The compiler-aware QATed neural network model 713 can include metadata that is not in the neural network model 711. The metadata can be generated from the QAT process 710. The metadata can include, for example, additional quantization parameters for the tiled-fused computation. During the compilation process 720, the additional quantization parameters included in the metadata can be applied to the compiler-aware QATed neural network model 713 after the tiling optimization of the tiled-fused computation has been performed. Then, the compiler-aware QATed neural network model 713 can go through the compilation process 720 to generate a compiled model 714. The compiled model 714 can be deployed onto the target hardware through a deployment process 730. The process 700 can be described in details as follows. The process 700 may start at step S701.

At step S701, the neural network model 711 can be input into the compilation process 720. In an example, the neural network model 711 can be trained through the QAT process 710. In an example, the neural network model 711 can be an untrained model, although the neural network model 711 can still be output from the QAT process 710. Through the compilation process 720, the compilation optimization information 712 can be obtained. In an example, compiler option information 715 can be used in the compilation process 720, and the compilation optimization information 712 can be generated based on the compiler option information 715. The compiler option information 715 can include, for example, hardware type information of the target hardware that the complied neural network model 714 is to be deployed onto. The hardware type information can indicate that the target hardware is a CPU, a GPU, an APU, a TPU, or the like. The process 700 can proceed to step S702.

At step S702, the obtained compilation optimization information 712 can be feedback to the QAT process 710. The QAT process 710 can train the neural network model 711 based on the compilation optimization information 712 to generate the compiler-aware QATed model 713. The process 700 can proceed to step S703.

At step S703, the compiler-aware QATed model 713 can be input into the compilation process 720. Through the compilation process 720, the compiler-aware QATed model 713 can be compiled into the compiled model 714. In an example, the compiler option information 715 can be used in the compilation process 720, and the compiled model 714 can be generated based on the compiler option information 715. The compiler option information 715 can include, for example, the hardware type information of the target hardware that the complied neural network model 714 is to be deployed onto. The process 700 can proceed to step S704.

At step S704, the compiled neural network model 714 can be deployed onto the target hardware through the deployment process 730.

According to aspects of the disclosure, a model quantization of a neural network model can be performed after a training process that trains the neural network model, and thus can be referred to as a post training quantization (PTQ) process.

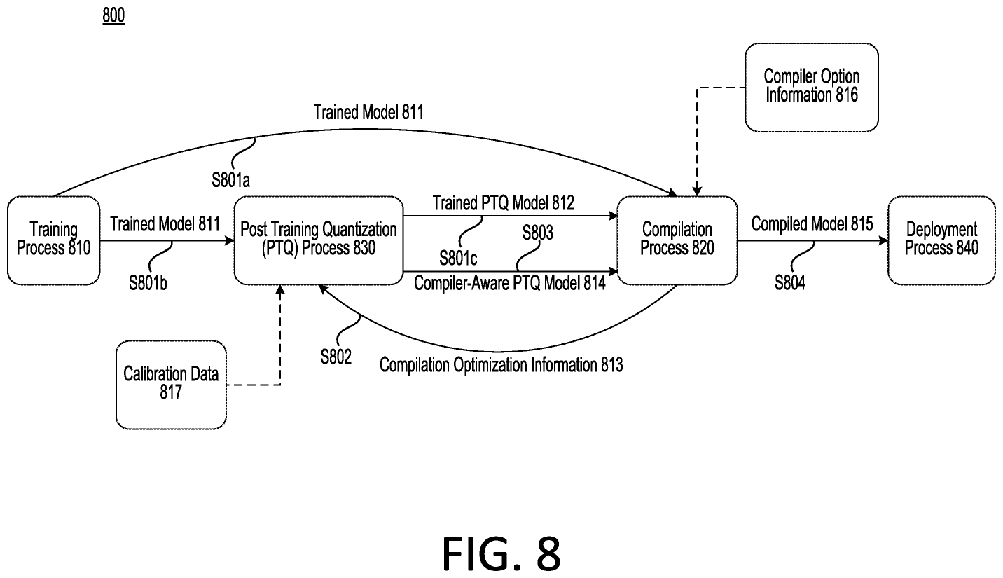

FIG. 8 shows an exemplary process 800 of obtaining a compiler-aware PTQ neural network model according to embodiments of the disclosure. In the process 800, compilation optimization information 813 of a compilation process 820 can be obtained by either inputting a trained model 811 or a trained PTQ model 812 into the compilation process 820. The trained model 811 can be an unquantized model that is trained through a training process 810. The trained PTQ model 812 can be a quantized model that is generated by inputting the trained model 811 into a PTQ process 830. The compilation optimization information 813 can include tiling and fusion configuration information of a tiled-fused computation to enhance the PTQ process 830. The compilation optimization information 813 can indicate (or include) one or more changes of the neural network model 811 during the compilation process 820. The one or more changes are based on hardware information of a target hardware that the neural network model 811 (or a compiled version of the neural network model 811) is to be deployed onto.

In an embodiment, when the compilation optimization information 813 is quantization dependent, the compilation optimization information 813 obtained by inputting the trained PTQ model 812 into the compilation process 820 can be more accurate than the compilation optimization information 813 obtained by inputting the trained model 811 into the compilation process 820.

The obtained compilation optimization information 813 can be feedback to the PTQ process 830 to generate a compiler-aware PTQ model 814. The compiler-aware PTQ model 814 can include metadata that is not in the trained PTQ model 812. The metadata can be generated from the PTQ process 830. The metadata can include, for example, additional quantization parameters for the tiled-fused computation. During the compilation process 820, the additional quantization parameters included in the metadata can be applied to the compiler-aware PTQ model 814 after the tiling optimization of the tiled-fused computation has been performed. The compiler-aware PTQ model 814 can go through the compilation process 820 to generate a compiled model 815. The compiled model 815 can be deployed onto the target hardware through a deployment process 840. The process 800 can be described in details as follows.

The process 800 can begin from either step S801a or S801b.

At step S801a, the trained neural network model 811, which is trained through the training process 810, can be input into the compilation process 820 to obtain the compilation optimization information 813. Then, the process 800 can proceed to step S802.

At step S801b, the trained neural network model 811 can be input into the PTQ process 830 to obtain the trained PTQ model 812. In an example, calibration data 817 can be used in the PTQ process 830, and the trained PTQ model 812 can be generated based on the calibration data 817. The calibration data 817 can include, for example, a small dataset that is representable to the inference data distribution. Then, the process 800 can proceed to step S810c.

At step S801c, the trained PTQ model 812 can be input into the compilation process 820 to obtain the compilation optimization information 813. Then, the process 800 can proceed to step S802.

In an example, compiler option information 816 can be used in the compilation process 820, and the compilation optimization information 813 can be generated based on the compiler option information 816. The compiler option information 816 can include, for example, hardware type information of the target hardware that the complied neural network model 815 is to be deployed onto. The hardware type information can indicate that the target hardware is a CPU, a GPU, an APU, a TPU, or the like.

At step S802, the compilation optimization information 813 obtained at step S801a or S801c can be feedback to the PTQ process 830. The PTQ process 830 can quantize the trained model 811 based on the compilation optimization information 813 to generate the compiler-aware PTQ model 814. In an example, the calibration data 817 can be used in the PTQ process 830, and the compiler-aware PTQ model 814 can be generated based on the compilation optimization information 813 and the calibration data 817. The calibration data 817 can include, for example, a small dataset that is representable to the inference data distribution. Then, the process 800 can proceed to step S803.

At step S803, the compiler-aware PTQ model 814 can be input into the compilation process 820. Through the compilation process 820, the compiler-aware PTQ model 814 can be compiled into the compiled model 815. In an example, the compiler option information 816 can be used in the compilation process 820, and the compiled model 815 can be generated based on the compiler option information 816. The compiler option information 816 can include, for example, the hardware type information of the target hardware that the complied neural network model 815 is to be deployed onto. The hardware type information can indicate that the target hardware is a CPU, a GPU, an APU, a TPU, or the like. Then, the process 800 can proceed to step S804.

At step S804, the compiled neural network model 815 can be deployed onto the target hardware through the deployment process 840.

It is noted that if the compilation process 820 is quantization dependent, the compilation optimization information 813 generated based on the unquantized model 811 and the quantized model 812 can be different. In such a case, the process 800 needs to begin from step S810b. That is, the compilation optimization information 813 needs to be generated based on the quantized model 812.

In FIG. 8, the PTQ process 830 is outside the compilation process 820, and thus can be referred to as a pre-compilation PTQ process. In an embodiment, the PTQ process 830 can be inside the compilation process 820, and thus can be referred to as an in-compilation PTQ process. In such as case, a compiler that performs the compilation process 820 can also perform the PTQ process 830.

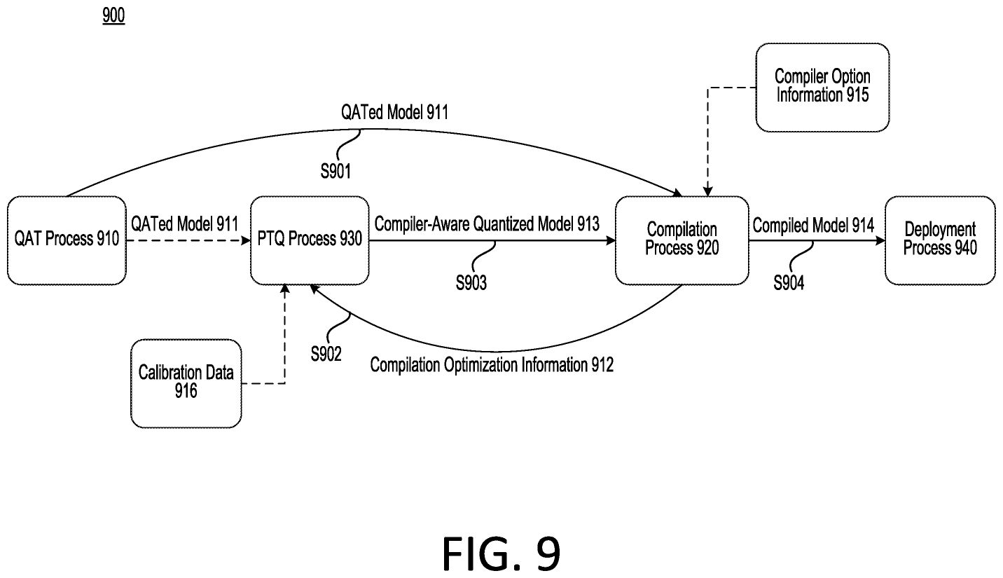

FIG. 9 shows another exemplary process 900 of obtaining a compiler-aware PTQ neural network model according to embodiments of the disclosure. The process 900 can include a QAT process 910 and a PTQ process 930. The QAT process 910 can train quantization parameters used to generate a QATed neural network model 911 while training the parameters of neural network model 911. After the QATed neural network model 911 is trained, compilation optimization information 912 of a compilation process 920 can be obtained by inputting the QATed neural network model 911 into the compilation process 920. The compilation optimization information 912 can include tiling and fusion configuration information of a tiled-fused computation to enhance the PTQ process 930. The compilation optimization information 912 can indicate (or include) one or more changes of the QATed neural network model 911 during the compilation process 920. The one or more changes are based on hardware information of a target hardware that the QATed neural network model 911 (or a compiled version of the QATed neural network model 911) is to be deployed onto.

The obtained compilation optimization information 912 can be feedback to the PTQ process 930. The PTQ process 930 can tune the quantization parameters in the QATed neural network model 911 based on compilation optimization information 912 to generate a compiler-aware quantized model 913. The PTQ process 930 can also compute tile-based quantization parameters that were not present in the QATed neural network model 911 before tiling. The compiler-aware quantized model 913 can include metadata that is not in the QATed neural network model 911. The metadata can be generated from the PTQ process 930. The metadata can include, for example, additional quantization parameters for the tiled-fused computation. During the compilation process 920, the additional quantization parameters included in the metadata can be applied to the compiler-aware quantized model 913 after the tiling optimization of the tiled-fused computation has been performed. The compiler-aware quantized model 913 can go through the compilation process 920 to generate a compiled model 914. The compiled model 914 can be deployed onto the target hardware through a deployment process 930. The process 900 can be described in details as follows. The process 900 may start at step S901.

At step S901, the QATed model 911, which is trained through the QAT process 910, can be input into the compilation process 920 to obtain the compilation optimization information 912. In an example, the compilation optimization information 912 can include tiling and fusion configuration information of a tiled-fused computation of the QATed model 911. The compilation optimization information 912 can indicate (or include) one or more modifications to the quantization parameters used to generate the compiled model 914 from the QATed model 911. The process 5900 can proceed to step S902.

In an example, compiler option information 915 can be used in the compilation process 920, and the compilation optimization information 912 can be generated based on the compiler option information 915. The compiler option information 915 can include, for example, hardware type information of the target hardware that the complied neural network model 914 is to be deployed onto. The hardware type information can indicate that the target hardware is a CPU, a GPU, an APU, a TPU, or the like.

At step S902, the compilation optimization information 912 can be feedback to the PTQ process 930. The PTQ process 930 can tune the quantization parameters in the QATed model 911 based on the compilation optimization information 912 to generate a compiler-aware quantized model 913. In an example, calibration data 916 can be used in the PTQ process 930, and the compiler-aware quantized model 913 can be generated based on the compilation optimization information 912 and the calibration data 916. The calibration data can include, for example, a small dataset that is representable to the inference data distribution. The process 900 can proceed to step S903.

At steps S903, the compiler-aware quantized model 913 can be input into the compilation process 920. Through the compilation process 920, the compiler-aware quantized model 913 can be compiled into the compiled model 914. In an example, the compiler option information 915 can be used in the compilation process 920, and the compiled model 914 can be generated based on the compiler option information 915. The compiler option information 915 can include, for example, the hardware type information of the target hardware that the complied neural network model 914 is to be deployed onto. The process 900 can proceed to step S904.

At step S904, the compiled neural network model 914 can be deployed onto the target hardware through the deployment process 940.

In FIG. 9, the PTQ process 930 is outside the compilation process 920, and thus can be referred to as a pre-compilation PTQ process. In an embodiment, the PTQ process 930 can be inside the compilation process 920, and thus can be referred to as an in-compilation PTQ process. In such as case, a compiler that performs the compilation process 920 can also perform the PTQ process 930.

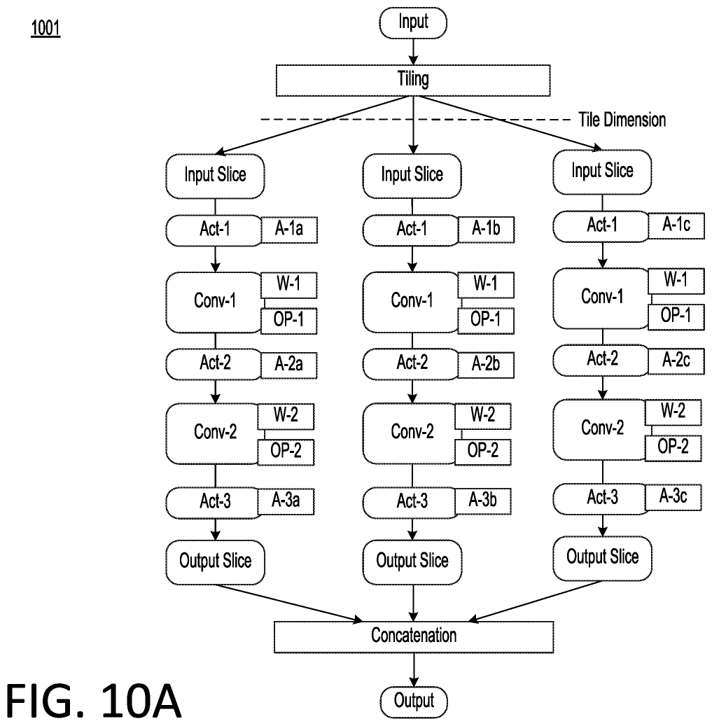

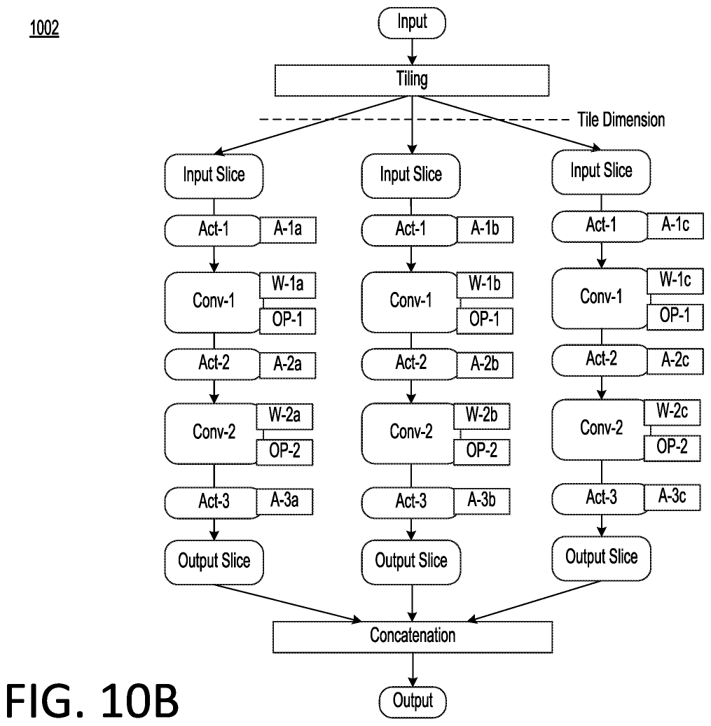

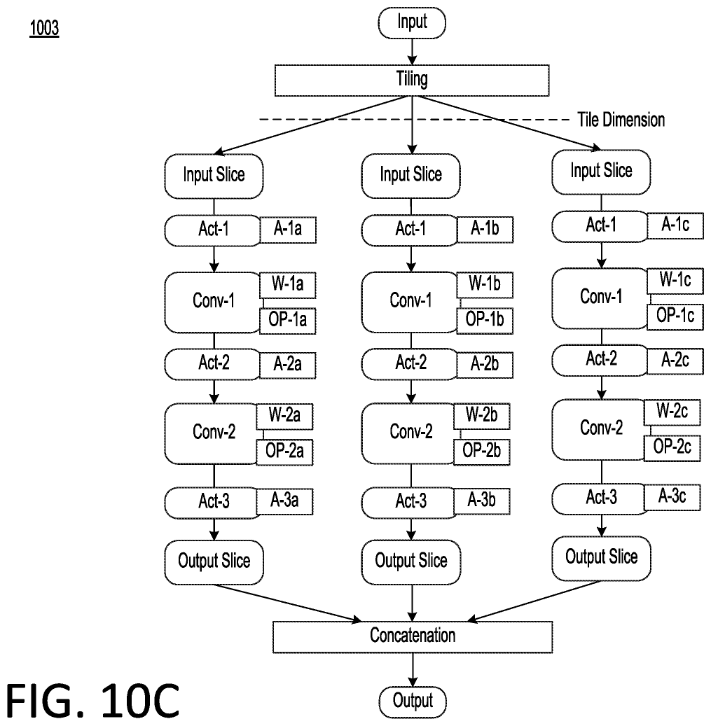

FIGS. 10A-10C show three exemplary neural network computation graphs 1001-1003, respectively, according to embodiments of the disclosure. Each of the graphs 1001-1003 can use a tiled-fused computation. In the tiled-fused computation, an input can be tiled into multiple input slices (or tiles), each input slice can go through a separate processing channel including multiple activation layers (or tensors) (e.g., Act-1, Act-2, and Act-3) and multiple operation layers (e.g., Conv-1 and Conv-2) to obtain a corresponding output slice (or tile), and the output slices can be merged into a concatenated output. In an example, an operation layer can be a convolution layer.

Further, each of the graphs 1001-1003 can apply a model quantization to a neural network model while training the neural network model. In an activation layer, the model quantization can be performed by using activation quantization parameters such as A-1a, A-1b, and A-1c in the graph 1001. In an operation layer, the model quantization can be performed by using weight quantization parameters such as W-1 and W-2 in the graph 1001.

According to aspects of the disclosure, the model quantization in each of the graphs 1001-1003 can be tile based (or per-channel based). For example, the activation quantization parameters can be different in a tile dimension (for example along the spatial dimension), and thus can be referred to as tiling-aware activation quantization parameters. For example, in the graph 1001, each of the activation quantization parameters A-1a, A-1b, and A-1c can be applied to quantize a separate input slice. The activation quantization parameters A-1a, A-1b, and A-1c can be different from each other, or one of the activation quantization parameters A-1a, A-1b, and A-1c can be different from others of the activation quantization parameters A-1a, A-1b, and A-1c.

In the graph 1001 of FIG. 10A, operation parameters (e.g., weights or biases) OP-1 and OP-2 of the operation layers Conv-1 and Conv-2 are not tile based. That is, the operation parameters are same in a tile dimension. For example, the operation parameter OP-1 can be used for all operation layers Conv-1 in the three processing channels each corresponding to a separate input slice. Further, the weight quantization parameters for quantizing the operation parameters OP-1 and OP-2 are not tile based. For example, the weight quantization parameter W-1 for quantizing the operation parameter OP-1 can be used for all operation layers Conv-1 in the three processing channels each corresponding to a separate input slice.

In the graph 1002 of FIG. 10B, the weight quantization parameters can be tile based. That is, each processing channel in the graph 1002 can have a separate weight quantization parameter for a same operation layer in a tile dimension. For example, the weight quantization parameters W-1a, W-1b, and W-1c can be used to quantize the OP-1 of the operation layers Conv-1 in the three processing channels, respectively. The weight quantization parameters W-1a, W-1b, and W-1c can be different from each other, or one of the weight quantization parameters W-1a, W-1b, and W-1c can be different from others of the weight quantization parameters W-1a, W-1b, and W-1c. However, in the graph 1002, the operation parameters OP-1 and OP-2 of the operation layers are not tile based, and a same operation parameter are used for the operation layers in the three processing channels in a tile dimension.

In the graph 1003, both the weight quantization parameters and the operation parameters of the operation layers can be tile based (e.g., with depthwise convolution layers). The operation parameters OP-1a, OP-1b, and OP-1c can be used in the operation layers Conv-1 for the three processing channels, respectively. The weight quantization parameters W-1a, W-1b, and W-1c can be used to quantize the OP-1a, OP-1b, and OP-1c, respectively. The operation parameters OP-1a, OP-1b, and OP-1c can be different from each other, or one of the operation parameters OP-1a, OP-1b, and OP-1c can be different from others of the operation parameters OP-1a, OP-1b, and OP-1c.

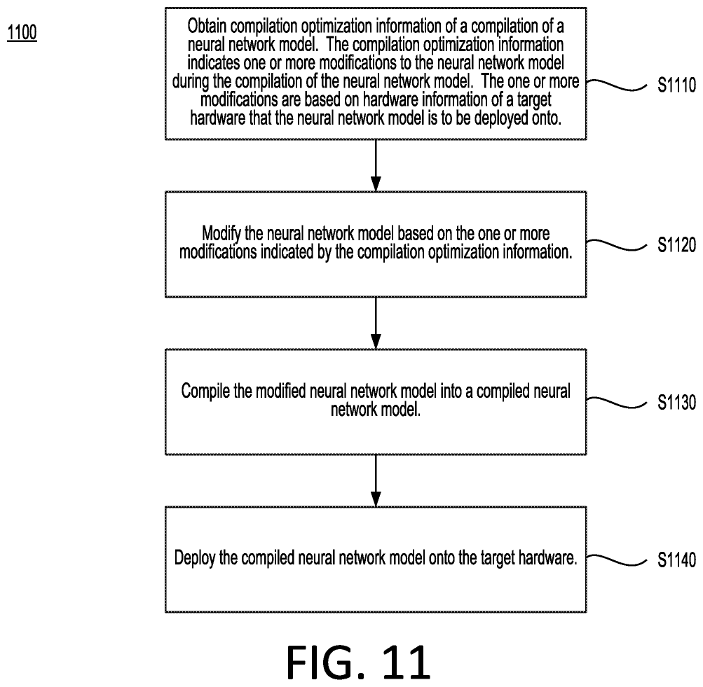

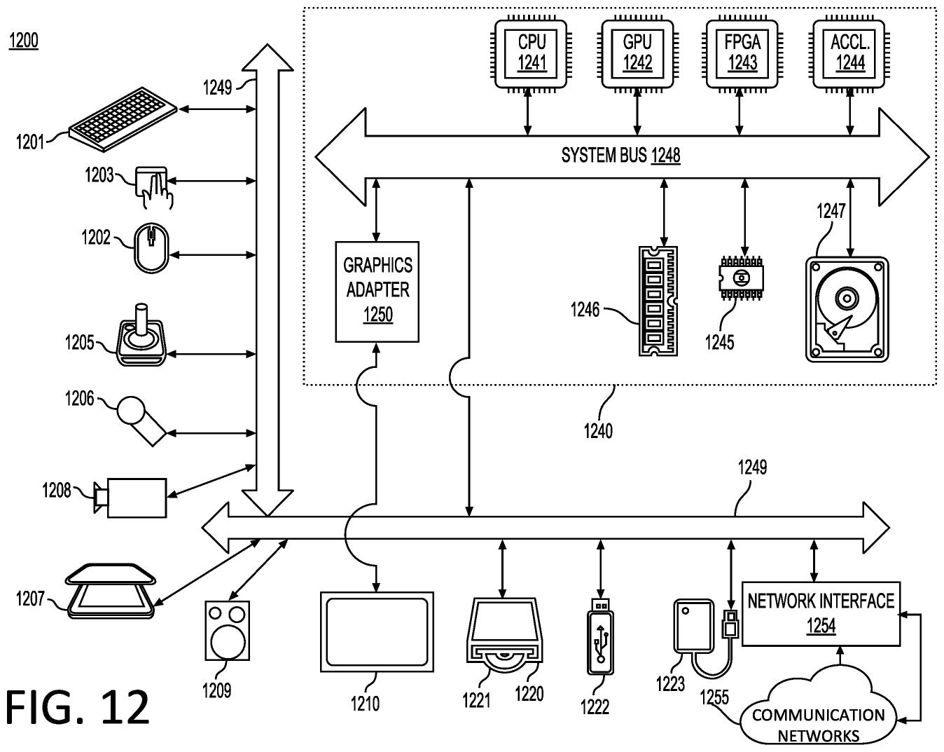

FIG. 11 shows a flowchart outlining a process 1100 according to embodiments of the disclosure. The process 1100 can be executed by processing circuitry (e.g., CPU, GPU, APU, TPU, or the like) of an apparatus such as a computer system 1200 in FIG. 12. The process 1100 may start at step S1110.

At step S1110, the process 1100 obtains compilation optimization information of a compilation of a neural network model. The compilation optimization information indicates one or more modifications to the neural network model during the compilation of the neural network model. The one or more modifications are based on hardware information of a target hardware that the neural network model is to be deployed onto. Then, the process 1100 proceeds to step S1120.

At step S1120, the process 1100 modifies the neural network model based on the one or more modifications indicated by the compilation optimization information. Then, the process 1100 proceeds to step S1130.

At step S1130, the process 1100 compiles the modified neural network model into a compiled neural network model. Then, the process 1100 proceeds to step S1140.

At step S1140, the process 1100 deploys the compiled neural network model onto the target hardware. Then, the process 1100 may terminate.

In an embodiment, the process 1100 modifies at least one of a topology, a computation order, a quantization parameter, or an operation parameter of an operation layer of the neural network model.

In an embodiment, the neural network model is an untrained model before the compilation optimization information is obtained, and the process 1100 trains the neural network model based on the one or more modifications indicated by the compilation optimization information.

In an embodiment, the neural network model is a trained model before the compilation optimization information is obtained, and the process 1100 retrains or fine-tunes the neural network model using the same training process based on the one or more modifications indicated by the compilation optimization information.

In an embodiment, the neural network model is a trained model before the compilation optimization information is obtained, the process 1100 calibrates the neural network model based on the one or more modifications indicated by the compilation optimization information. In an example, the process 1100 calibrates the neural network model based on the one or more modifications indicated by the compilation optimization information and calibration data including a small dataset that is representable to the inference data distribution.

In an embodiment, the compilation of the neural network model includes a tiled-fused computation of the neural network model, and the compilation optimization information indicates tiling configuration information and fusion configuration information of the tiled-fused computation. The tiled-fused computation can tile and fuse the neural network model.

In an embodiment, the hardware information of the target hardware includes hardware type information of the target hardware.

In an embodiment, the process 1100 applies a model quantization to the neural network model based on the one or more modifications indicated by the compilation optimization information. In an example, the model quantization is applied during or after a training process that trains the neural network model.

This disclosure provides methods of achieving a finer grain quantization for a neural network model in a tile dimension. The methods are based on a target hardware that the neural network model is to be deployed onto. The target hardware can perform a tiled-fused computation on the neural network model. Through the finer grain quantization, the methods can improve a model accuracy of a CNN-based (or any tile-based) quantized model. It is noted that a tile-based quantized model can be any quantized model that contains tileable operations. The methods can be used for QAT and/or PTQ, and do not need a hardware modification and/or redesign. In addition, the methods do not introduce an extra overhead during an inference since the quantization parameters for the tiled tensors or layers are reused in the methods.

In a method, the neural network model can be first sent to a compiler or a separate tool that requires hardware information of the target hardware to acquire compilation optimization information before or after the QAT or PTQ process. The compilation optimization information can indicate or include tiling and fusion configuration information of a tiled-fused computation of the neural network model. The compilation optimization information can be used to train the neural network model to achieve a finer grain quantization. Quantization parameters for tiled tensors (or layers) can be stored alongside or embedded within a quantized model as metadata to be used for a compilation of the quantized model. In an example, the compilation process can require input samples for calibration when the tiled-fused computation is enabled. The input samples can be from calibration data including a small dataset that is representable to the inference data distribution.

The techniques described above, can be implemented as computer software using computer-readable instructions and physically stored in one or more computer-readable media. For example, FIG. 12 shows a computer system (1200) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more CPUs, GPUs, and the like.

The instructions can be executed on various types of computers or components thereof, including, for example, personal computers, tablet computers, servers, smartphones, gaming devices, internet of things devices, and the like.

The components shown in FIG. 12 for computer system (1200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1200).

Computer system (1200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1201), mouse (1202), trackpad (1203), touch screen (1210), data-glove (not shown), joystick (1205), microphone (1206), scanner (1207), and camera (1208).

Computer system (1200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1210), data-glove (not shown), or joystick (1205), but there can also be tactile feedback devices that do not serve as input devices), audio output devices (such as: speakers (1209), headphones (not depicted)), visual output devices (such as screens (1210) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens (1210)) can be connected to a system bus (1248) through a graphics adapter (1250).

Computer system (1200) can also include human accessible storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1200) can also include a network interface (1254) to one or more communication networks (1255). The one or more communication networks (1255) can for example be wireless, wireline, optical. The one or more communication networks (1255) can further be local, wide-area, metropolitan, vehicular and industrial, real-time, delay-tolerant, and so on. Examples of the one or more communication networks (1255) include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1249) (such as, for example USB ports of the computer system (1200)); others are commonly integrated into the core of the computer system (1200) by attachment to a system bus as described below (for example Ethernet interface into a PC computer system or cellular network interface into a smartphone computer system). Using any of these networks, computer system (1200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1240) of the computer system (1200).

The core (1240) can include one or more CPUs (1241), GPUs (1242), specialized programmable processing units in the form of Field Programmable Gate Areas (FPGA) (1243), hardware accelerators for certain tasks (1244), graphics adapters (1250), and so forth. These devices, along with Read-only memory (ROM) (1245), Random-access memory (1246), internal mass storage (1247) such as internal non-user accessible hard drives, SSDs, and the like, may be connected through the system bus (1248). In some computer systems, the system bus (1248) can be accessible in the form of one or more physical plugs to enable extensions by additional CPUs, GPUs, and the like. The peripheral devices can be attached either directly to the core's system bus (1248), or through a peripheral bus (1249). In an example, the screen (1210) can be connected to the graphics adapter (1250). Architectures for a peripheral bus include PCI, USB, and the like.

CPUs (1241), GPUs (1242), FPGAs (1243), and accelerators (1244) can execute certain instructions that, in combination, can make up the aforementioned computer code. That computer code can be stored in ROM (1245) or RAM (1246). Transitional data can be also be stored in RAM (1246), whereas permanent data can be stored for example, in the internal mass storage (1247). Fast storage and retrieve to any of the memory devices can be enabled through the use of cache memory, that can be closely associated with one or more CPUs (1241), GPU (1242), mass storage (1247), ROM (1245), RAM (1246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1200), and specifically the core (1240) can provide functionality as a result of processor(s) (including CPU, GPU, FPGA, accelerators, and the like) executing software embodied in one or more tangible, computer-readable media. Such computer-readable media can be media associated with user-accessible mass storage as introduced above, as well as certain storage of the core (1240) that are of non-transitory nature, such as core-internal mass storage (1247) or ROM (1245). The software implementing various embodiments of the present disclosure can be stored in such devices and executed by core (1240). A computer-readable medium can include one or more memory devices or chips, according to particular needs. The software can cause the core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system can provide functionality as a result of logic hardwired or otherwise embodied in a circuit (for example: accelerator (1244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for constructing a neural network, the method comprising:
obtaining compilation optimization information of a compilation of a neural network model, the compilation optimization information indicating one or more modifications to the neural network model during the compilation of the neural network model, and the one or more modifications being based on hardware information of a target hardware that the neural network model is to be deployed onto;
modifying the neural network model based on the one or more modifications indicated by the compilation optimization information;
compiling the modified neural network model into a compiled neural network model; and
deploying the compiled neural network model onto the target hardware.

2. The method of claim 1, wherein the modifying includes:
modifying at least one of a topology, a computation order, a quantization parameter, or an operation parameter of an operation layer of the neural network model.

3. The method of claim 1, wherein the neural network model is an untrained model before the compilation optimization information is obtained, and the modifying includes:
training the neural network model based on the one or more modifications indicated by the compilation optimization information.

4. The method of claim 1, wherein the neural network model is a trained model before the compilation optimization information is obtained, and the modifying includes:
retraining or tuning the neural network model based on the one or more modifications indicated by the compilation optimization information.

5. The method of claim 1, wherein the neural network model is a trained model before the compilation optimization information is obtained, the modifying includes:
calibrating the neural network model based on the one or more modifications indicated by the compilation optimization information.

6. The method of claim 5, wherein the calibrating includes:
calibrating the neural network model based on the one or more modifications indicated by the compilation optimization information and calibration data including a dataset that is representable to an inference data distribution.

7. The method of claim 1, wherein the compilation of the neural network model includes a tiled-fused computation of the neural network model, and the compilation optimization information indicates tiling configuration information and fusion configuration information of the tiled-fused computation.

8. The method of claim 1, wherein the hardware information of the target hardware includes hardware type information of the target hardware.

9. The method of claim 1, wherein the modifying includes:
applying a model quantization to the neural network model based on the one or more modifications indicated by the compilation optimization information.

10. The method of claim 9, wherein the model quantization is applied during or after a training process that trains the neural network model.

11. A system for constructing a neural network, the system comprising processing circuitry configured to:
obtain compilation optimization information of a compilation of a neural network model, the compilation optimization information indicating one or more modifications to the neural network model during the compilation of the neural network model, and the one or more modifications being based on hardware information of a target hardware that the neural network model is to be deployed onto;
modify the neural network model based on the one or more modifications indicated by the compilation optimization information;
compile the modified neural network model into a compiled neural network model; and
deploy the compiled neural network model onto the target hardware.

12. The system of claim 11, wherein the processing circuitry is configured to:
modify at least one of a topology, a computation order, a quantization parameter, or an operation parameter of an operation layer of the neural network model.

13. The system of claim 11, wherein the neural network model is an untrained model before the compilation optimization information is obtained, and the processing circuitry is configured to:
train the neural network model based on the one or more modifications indicated by the compilation optimization information.

14. The system of claim 11, wherein the neural network model is a trained model before the compilation optimization information is obtained, and the processing circuitry is configured to:
retrain or tune the neural network model based on the one or more modifications indicated by the compilation optimization information.

15. The system of claim 11, wherein the neural network model is a trained model before the compilation optimization information is obtained, the processing circuitry is configured to:
calibrate the neural network model based on the one or more modifications indicated by the compilation optimization information.

16. The system of claim 15, wherein the processing circuitry is configured to:
calibrate the neural network model based on the one or more modifications indicated by the compilation optimization information and calibration data including a dataset that is representable to an inference data distribution.

17. The system of claim 11, wherein the compilation of the neural network model includes a tiled-fused computation of the neural network model, and the compilation optimization information indicates tiling configuration information and fusion configuration information of the tiled-fused computation.

18. The system of claim 11, wherein the hardware information of the target hardware includes hardware type information of the target hardware.

19. The system of claim 11, wherein the processing circuitry is configured to:
apply a model quantization to the neural network model based on the one or more modifications indicated by the compilation optimization information.

20. The system of claim 19, wherein the model quantization is applied during or after a training process that trains the neural network model.
